(19) United States
(12) Patent Application Publication
(10) Pub. No.: US 2006/0152941 A1
(43) Pub. Date: Jul. 13, 2006

(54) Light emitting antenna

(76) Inventor: Chang Kai Chiang, Taipei Hsien (TW)

Correspondence Address: Chang Kai Chiang, 235 Chung - Ho, Box 8-24, Taipei, TW

(21) Appl. No.: 11/052,314

(22) Filed: Feb. 8, 2005

(30) Foreign Application Priority Data
Jan. 11, 2005 (TW) 94200514

(51) Int. Cl. B60Q 1/26

(52) U.S. Cl. 362/540; 362/193; 362/544; 362/545; 362/549; 362/202; 362/208

(57) ABSTRACT

A light emitting antenna comprises a main body, a cap member and an inner barrel. The main body further comprises a first main body with a first receptacle for housing said inner barrel and a second main body. The first and the second main bodies will be in integrated by the engagement between respective frictional sections of screwed pattern thereon. The inner barrel is provided with a receptacle for housing batteries and a light emitting object that goes through a top end of the first main body when the inner barrel is inserted into the first main body. The batteries will power the light emitting object so that the light emitting antenna, mounted on a car antenna base will have a flashing effect, or it can be used as an emergent light source when taken off the car.

### FIELD OF THE INVENTION

The present invention relates to antenna structures, more particularly to a light emitting antenna for automobiles.

### BACKGROUND OF THE INVENTION

Antennae are a standard equipment of automobiles for enhancing the reception of radio signals. The car antennae of the prior art can be of a contractible type, a fixed length type, and a short type.

A long antenna surely has a better signal-receiving effect, but its height makes itself vulnerable and an inconvenience for the car. Therefore, short antennae with enhanced signal-receiving capability have become popular.

However, the antennae of the prior art exist for a single purpose. They do not provide any decorative function, which cannot satisfy fancy car drivers.

### SUMMARY OF THE INVENTION

Accordingly, the primary objective of the present invention is to provide a light emitting antenna having a flashing effect for enhancing the decoration of a car and the security of a car when driving at night.

The secondary objective of the present invention is to provide a light emitting antenna that can be taken from a car for being an emergence light source.

To achieve the above objectives, the light emitting antenna comprises a main body, a cap member and an inner barrel. The main body further comprises a first main body with a first receptacle for housing said inner barrel and a second main body. The first and the second main bodies will be in integrated by the engagement between respective frictional sections of screwed pattern thereon. The inner barrel is provided with a receptacle for housing batteries and a light emitting object that goes through a top end of the first main body when the inner barrel is inserted into the first main body. The batteries will power the light emitting object so that the light emitting antenna, mounted on a car antenna base will have a flashing effect, or it can be used as an emergent light source when taken off the car.

The various objects and advantages of the present invention will be more readily understood from the following detailed description when read in conjunction with the appended drawings.

### BRIEF DESCRIPTION OF THE DRAWINGS

FIG. 1 is an exploded perspective view of a light emitting antenna of the present invention.

FIG. 2 is a perspective view of the light emitting antenna in FIG. 1.

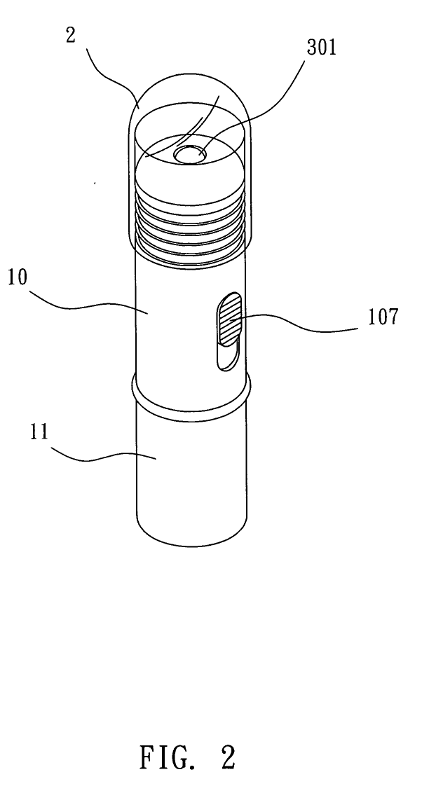

FIG. 3 is a lateral cross-sectional view of the light emitting antenna in FIG. 1.

FIG. 4 illustrates the present invention mounted on a car.

### DETAILED DESCRIPTION OF THE PREFERRED EMBODIMENTS

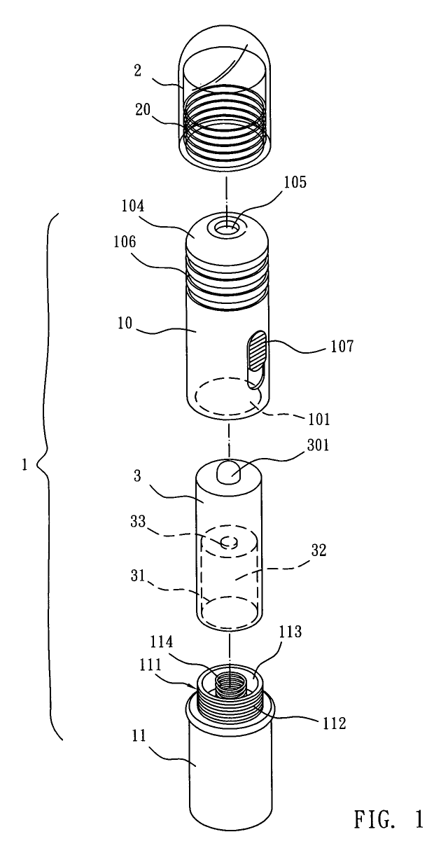

Referring to FIG. 1, 2 and 3, a light emitting antenna according to the present invention comprises a main body 1, a cap member 2 and an inner barrel 3, all of cylindrical cross section. The main body 1 further comprises a first main body 10 and a second main body 11, which are of the same diameter. One end of the first main body 10 is provided with an opening 101 connecting to a first receptacle 102 in the first main body 10.

A first screwed section 103 is formed around the inner wall of the receptacle 102. The other end of the first main body 10 is provided with a light cover 104 having a hole 105 for the passage of a light emitting object 301. Further, the lateral outer wall of the first main body 10 is provided with a power switch 107 for connecting the light emitting object 301 to a power source.

An end of the second main body 11 is provided with a projected member 111 having an outer diameter same as the inner diameter of the opening 101 of the first main body 10, and the outer lateral surface of the projected member 111 is provided with a second screwed section 112 capable of being engaged with the first screwed section 103, whereby the first main body 10 and the second main body 11 are integrated by the engagement of the first screwed section 103 and the second screwed section 112.

The central part of the projected member 111 is a cylindrical recess 113 provided with a first conducting member 114, which is a metallic spring in the preferred embodiment.

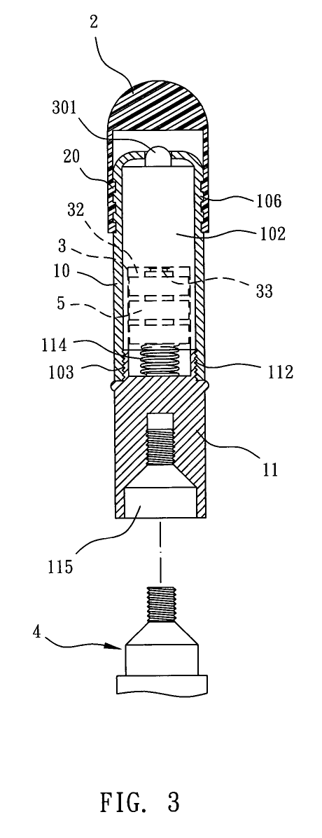

Further, the end of the second main body 11 far from the projected member 11 is provided with a recessed connection space 115 for connecting an antenna base 4 on a car body, as shown in FIG. 3. The shape of the recessed connection space 115 is compatible with the contour of the antenna base 4, and the connection therebetween is accomplished by screwed members.

The inner barrel 3 is for the insertion into the first receptacle 102 of the first main body 10, with one end provided with the light emitting object 301, such as a light emitting diode (LED), and the other end provided with an opening 31 connected to a second receptacle 32. The opening 31 and the second receptacle 32 are of same diameter. The second receptacle 32 is a space for containing a power source, such as a battery 5, as shown in FIG. 3. Further, a second conducting member 33 is mounted on the innermost wall of the second receptacle 32, whereby the second conducting member 33, the battery 5, the first conducting member 114, the light emitting object 301 and the power switch 107 are integrated to form an electric loop.

The cap member 2 is made of an insulating material, such as plastic or rubber. The cap member 2 will be mounted onto the end of the first main body 10 where the light emitting object 301 is exposed. Since the cap member 2 is made of a flexible material, it can fit tightly within the first main body 10, whereby the main body 1 and the light emitting object 301 therein will be protected from lightening shock.

To enhance the coupling of the cap member 2 and the first main body 10, a first frictional section of screwed pattern 106 can be formed on the outer surface of the first main body 10,and, further, a second frictional section of screwed pattern 20 can be formed on the inner surface of the cap member 2, in a corresponding position to the first frictional section of screwed pattern 106.

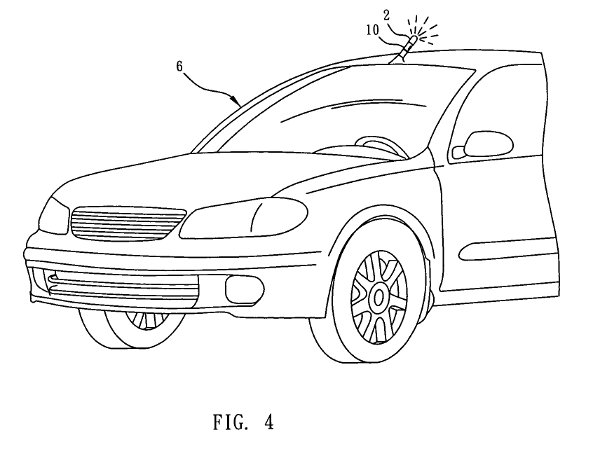

As shown in FIG. 4, the main body 1 after various parts being assembled will be mounted on an antenna base 4 of a car 6 by the engagement between the recessed connection space 115 of the main body 1 and the antenna base 4. (Since the antenna base 4 is a standard part of a car, the detailed structure thereof will not be discussed further.) The light emitting object 301 of the main body 1 can be turned on by the power switch 107 on the main body 1, producing a flashing effect.

It a further advantage of the present invention that a driver can take the main body 1 off the car 6 to use as an independent light source in an emergent situation.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A light emitting antenna, comprising:
a first main body provided with a first receptacle of predetermined depth, said first receptacle having an opening at a first end of said first main body of same diameter as said first receptacle, said first receptacle further including a first screwed section formed over an inner wall thereof, a second end of said first main body being provided with a light cover having a hole for the passage of a light emitting object;
a second main body provided with a projected member at a first end thereof, said projected member having an outer diameter same as said inner diameter of said opening of said first main body, a second screwed section capable of being engaged with said first screwed section being formed on an outer lateral surface of said projected member, whereby said first main body and said second main body will be integrated by the engagement of said first screwed section and said second screwed section, said projected member further including a first conducting member in a central part of said projected member, a recessed connection space being formed at a second end of said second main body for connecting an antenna base of a car; and
an inner barrel for the insertion into said first receptacle of said first main body, a first end of said inner barrel being provided with said light emitting object, a second end of said inner barrel being provided with an opening connected to a second receptacle therein of predetermined depth and for housing a power source, said opening and said second receptacle being of same diameter, said second receptacle further including a second conducting member mounted on an inner wall thereof, whereby said second conducting member, said power source, said first conducting member and said light emitting object will form an electric loop.

2. The light emitting antenna of claim 1 wherein said second end of said first main body at which said light emitting object is exposed further includes a cap member made of an insulting material for protecting said first main body from lightening shock.

3. The light emitting antenna of claim 2 wherein said material making said cap member is selected from plastic and rubber so that said cap member is flexible and can coupled tightly with said first main body.

4. The light emitting antenna of claim 2 wherein a first frictional section of screwed pattern is formed on an outer surface of said first main body, in a position corresponding to an inner wall of said cap member, for enhancing the coupling of said cap member and said first main body.

5. The light emitting antenna of claim 4 wherein a second frictional section of screwed pattern is formed on the inner surface of said cap member, in a corresponding position to said first frictional section of screwed pattern for enhancing the coupling of said cap member and said first main body.

6. The light emitting antenna of claim 1 wherein an outer surface of said first main body is further provided with a power switch, whereby said power switch, said second conducting member, said power source, said first conducting member and said light emitting object will form an electric loop.

7. The light emitting antenna of claim 1 wherein said light emitting object is selected from a regular light emitting diode and a high-power light emitting diode.

8. The light emitting antenna of claim 1 wherein said power source carried within said second receptacle is a plurality of batteries.
